(19) United States
(12) Patent Application Publication
(10) Pub. No.: US 2005/0052733 A1
(43) Pub. Date: Mar. 10, 2005

(54) AN INVERTED MICROSCOPE

(76) Inventors: Keisuke Tamura, Tokyo (JP); Yasushi Aono, Yokohama-shi (JP)

Correspondence Address: Jones & Volentine;12200 Sunrise Valley Dr., Suite 150, Reston, VA, 20191, US

(21) Appl. No.: 09/812,690

(22) Filed: Mar. 21, 2001

(30) Foreign Application Priority Data
Mar. 21, 2000 (JP) P2000-78725
Sep. 22, 2000 (JP) P2000-289466

(51) Int. Cl. G02B 21/06

(52) U.S. Cl. 359/385

(57) ABSTRACT

A microscope includes an objective lens, an image-forming lens, a reflecting mirror for directing transmitted light passing through the image-forming lens to a front side of the microscope, and a first optical element for directing light from the image-forming lens to an imaging optical path running to a backside of the microscope. The first optical element is disposed between the image-forming lens and the reflecting mirror, with a port disposed in the imaging optical path, and an imaging device coupled to the port. The imaging device includes an image plane, the image plane substantially corresponding to the focal plane.

### CROSS REFERENCE TO RELATED APPLICATION

This application is based on and claims priority of Japanese Patent Application No. Hei 12-78725 filed on Mar. 21, 2000, and Japanese Patent Application No. Hei 12-289466 filed on Sep. 22, 2000, the contents of which are incorporated herein by reference.

### BACKGROUND OF THE INVENTION

1. Field of the Invention

The present invention relates to a microscope using an imaging device, such as a TV camera, or an optical camera. Also the present invention relates to a microscope for operating on a sample by using a laser beam, and for both observing the sample and carrying out the operation by using the laser beam at the same time.

2. Description of the Related Art

An inverted microscope is disclosed in the U.S. Pat. No. 5,777,783. This inverted microscope can optically observe a sample via an eyepiece, and image a magnified image of the sample by means of a 35 mm camera, or a TV camera which is attached on a frame of the inverted microscope. This inverted microscope is in practical use. This kind of the inverted microscope captures the magnified image by means of the 35 mm camera, or the TV camera, so that an image magnified by an objective lens is focused by an image-forming lens, and then the image is led to an image capturing optical path of the 35 mm camera, or the TV camera by an optical element. In this case, an optical path which light passes through is selected from three phases by switching the optical element in the optical path. The optical paths of these three phases are mutually perpendicular to each other, and respectively directed to a side port, a bottom face port, or front port of the inverted microscope. One of these ports is selected by switching the optical element so as to selectively capture the image of the 35 mm camera, or the TV camera.

On the other hand, a microscope having an application for operating a sample by using a laser beam is disclosed in Japanese Laid-Open Patent Publication No. Hei 8-234110 as an optical tweezers. There are some other applications for operating the sample with a laser beam, for example, “Laser Killing”, and “Laser Ablation”. The “Laser Killing” is an application for examining a function of a cell by killing the cell by using an ultraviolet laser beam. “Laser Ablation” is an application for examining an expression of a gene by using a laser beam incident on a cell in order to heat the cell.

A microscope having at least one of the applications explained above includes a TV camera for imaging a phenomenon of a cell by using a reflected illumination fluorescence microscope. Since observation light from the cell includes a reflected laser beam, the TV camera is used as a monitor for observing the phenomenon with reflected illumination fluorescence observation during the period when the laser beam is irradiated on the cell. By using the monitor, researchers can avoid looking at a laser beam directly. For example, Japanese Laid-Open Patent Publication No. Hei 8-234110 discloses an arrangement where an optical element which deflects light toward the TV camera is disposed in an observation optical path with a relay lens which forms an image on the basis of the observation light.

Furthermore, it is known in the art to dispose a dichroic mirror in an optical path to deflect a laser beam to a sample. Japanese Laid-Open Patent Publication No. Hei 6-167654 discloses using a reflected illumination light system to direct a laser beam inside the microscope. Japanese Laid-Open Patent Publication No. Hei 8-234110 discloses that a means for dividing a wavelength of fluorescence is disposed in a microscope to irradiate a laser beam onto a sample, and to direct fluorescence from the sample to an observation optical system.

However, the conventional microscopes explained above have following shortcomings.

Recently, in the field of life sciences, a highly sensitive imaging device and a fluorescent reagent have been developed. As a result, many tests such as low level fluorescence observation and low level photometry have been carried out to detect low level light which humans can not see by their eyes. At the same time when these above tests are carried out, it is known to inject a gene tagged with a fluorescence dye into a cell by operating on a sample. Patch clamping for measuring a current shift of the cell membrane for measuring an ion change is also known in the art. Micromanipulators are often used inconnection with such injecting and patch clamping.

However, in case that the TV camera is attached to a side port of the microscope, the micromanipulator physically interferes with the TV camera as the micromanipulator is set at the lateral space of the microscope to precisely carry out the operation. So, it becomes impossible to operate the micromanipulator if the TV camera is attached to the side port of the microscope. Even if the micromanipulator is placed far from the microscope so as not to interfere with the TV camera, the situation exists where a tip of the micromanipulator vibrates easily because a long micromanipulator is needed to make it reach the sample. As a result, it is not possible to precisely operate the cell, and measure the current when operating on the cell and measuring the current.

Even if the TV camera is attached to the bottom face port to take a low level observation image with high efficiency on the basis of a primary image transmitted through the objective lens, it is necessary to make a hole in a desk to set the TV camera, or to make something to insert between the desk and the bottom face of the microscope to raise the microscope because the TV camera is placed close to the bottom face of the microscope. As a result, equipment for the microscope will be of large scale.

Furthermore, conventionally, the TV camera, or a 35 mm camera (hereinafter called a camera) is attached to the microscope. In this case, the front port is used as a port to attach the camera to the microscope. However, the microscope has a visual observation optical path, and so on, so that the depth of the microscope becomes large, and the position of the primary image is located far from the front port. As a result, there is little choice but to locate the camera inside the microscope when trying to locate the camera at the position of the primary image. That is, the design of the microscope is physically limited. Therefore, in a case where the front port is used as a port to attach the camera to the microscope, the microscope is designed to irradiate a secondary image to the camera. The secondary image is formed by the primary image transmitted through a rely lens. The size of the secondary image is 2 to 2.5 times as large as that of the primary image. The secondary image is undesirable for observing low level light because the amount of light decreases through the relaying of light. Even if the camera is attached to the front port, the distance between the researcher and a TV cable connected to the backside of the TV camera is too close to permit the researcher freedom of operation.

With regard to an application where a sample can be observed while operating on the sample by using a laser beam, it is important to precisely focus the laser beam on a focal point of the objective lens. However, a typical microscope is not manufactured with this type of application in mind. Therefore, in case where the objective lens is changed from one to another one which has a different focal point, the laser beam will not be focused on the most appropriate position of the objective lens, and then it is impossible to precisely operate on the sample.

Furthermore, an optical element inserted into an optical path, for example, a dichroic mirror, is changed corresponding to different types of laser beams, and wavelengths of excitation light. Accordingly, in a case where many types of laser beams, and wavelengths of excitation light are use, it takes a lot of time to change the optical element(s), and then it becomes too much of a bother to operate the microscope.

In a case where a researcher carries out visual observation, there is a possibility that a laser beam will leak out to an eyepiece because optical elements, for example, the dichroic mirror, and so on, are disposed in an observation optical path.

### BRIEF SUMMARY OF THE INVENTION

The present invention provides a microscope which overcome these problems. One embodiment of the present invention includes an objective lens disposed below a sample and an image-forming lens with a focal plane for focusing observation light from the objective lens. Also included is a reflecting mirror for directing transmitted light passing through the image-forming lens to a front side of the microscope and a first optical element for directing light from the image-forming lens to an imaging optical path running to a backside of the microscope. The first optical element is disposed between the image-forming lens and the reflecting mirror. A port is disposed in the imaging optical path, and an imaging device is coupled to the port, the imaging device comprising an image plane which substantially corresponds to the focal plane.

### BRIEF DESCRIPTION OF THE DRAWINGS

The accompanying drawings, which are incorporated in and constitute a part of the specification, illustrate exemplary embodiments of the invention, and together with the general description above and the detailed description of illustrative embodiments given below, serve to explain the principles of the invention.

FIG. 1 is an oblique perspective diagram of an inverted microscope of a first embodiment of the invention to show a schematic diagram of the microscope, and the positions of interrelated optical elements.

FIG. 2 is a lateral perspective view of the inverted microscope of the embodiment of FIG. 1.

FIG. 3 illustrates a schematic diagram of a second embodiment of the inverted microscope of the present invention.

FIGS. 4(a), and 4(b) are a schematic diagrams of a substantial part of a third embodiment of the inverted microscope of the present invention.

FIG. 5 is an oblique perspective diagram of a fourth embodiment of an inverted microscope according to the present invention to showing a schematic diagram of the microscope, and positions of interrelated optical elements.

FIG. 6 illustrates a schematic diagram of a substantial part of the fourth embodiment of the inverted microscope of the present invention.

FIG. 7 illustrates a schematic diagram of a substantial part of the fifth embodiment of the inverted microscope of the present invention.

FIG. 8 illustrates a schematic diagram of a substantial part of the sixth embodiment of the inverted microscope of the present invention.

### DETAILED DESCRIPTION

(First Illustrative Embodiment)

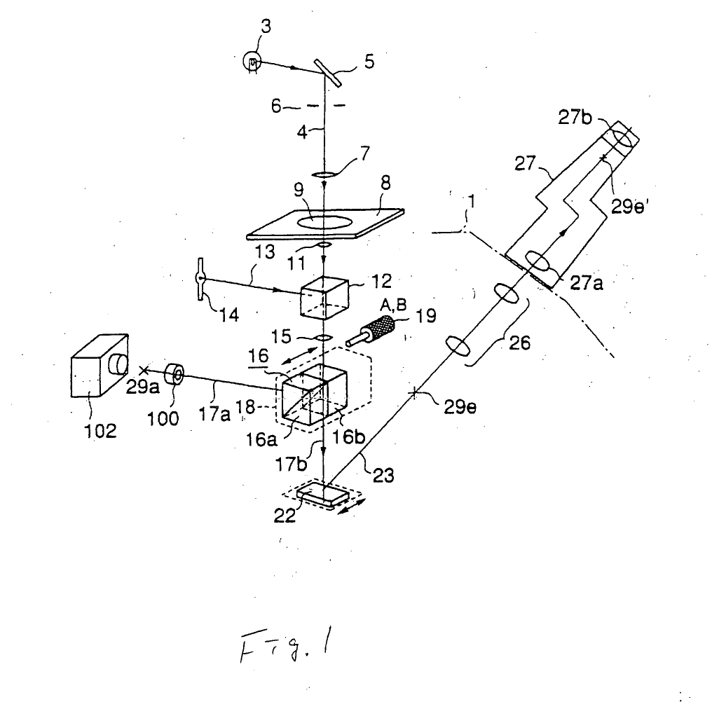

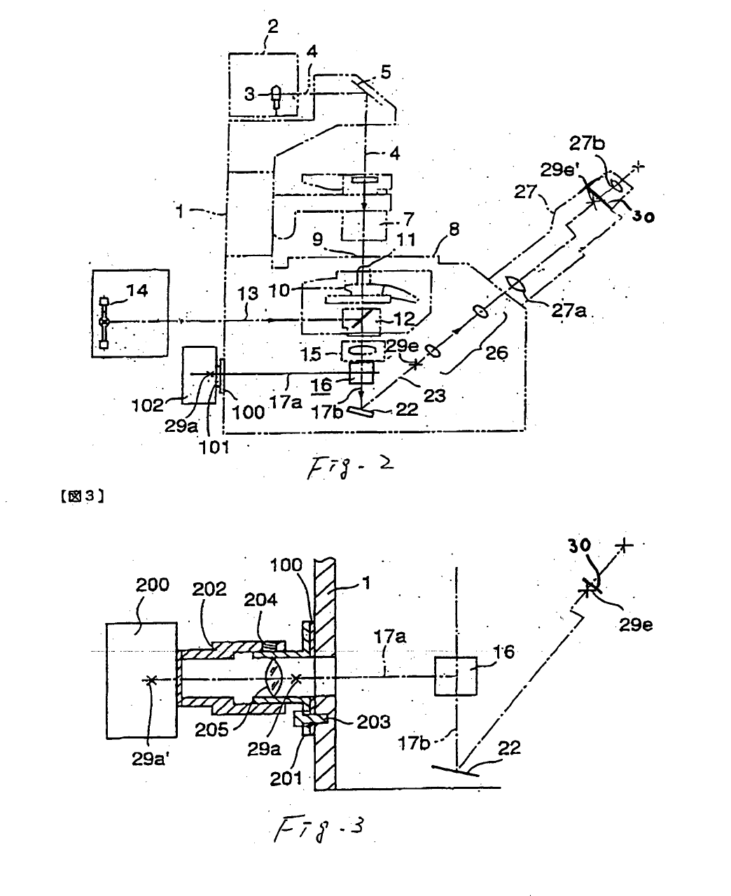

FIGS. 1 and 2 illustrate a schematic diagram of an inverted microscope referred to a first embodiment of this invention. FIG. 1 is an oblique perspective diagram of the inverted microscope of the first embodiment to show the position of each of the interrelated optical elements. FIG. 2 is a lateral perspective view of the inverted microscope of the first embodiment.

In FIGS. 1 and 2, an illumination housing 2 is disposed at the top end of a frame 1. A light source 3 is contained in the illumination housing 2.

A light beam 4 emitted from light source 3 is reflected by a reflecting mirror 5, and then the light beam 4 goes downward. The light beam 4 reflected by the reflecting mirror 5 transits a field stop 6, and a condenser lens 7. The light beam 4 transmitted through the condenser lens 7 is focused on a sample 9 on a stage 8 by means of the condenser lens 7.

Light transmitted through the sample 9 is incident on an objective lens 11 disposed below the stage 8. The objective lens 11 is supported by a revolver 10. Light transmitted through the objective lens 11 is converted to light imaged at infinity. Infinity imaged light from the objective lens 11 is incident on a fluorescent cube 12 integrated with a dichroic mirror. The dichroic mirror is inclined at an angle of 45 degrees to the optical axis of light from the objective lens 11. The fluorescent cube 12 preferably has an excitation filter (not shown), and an absorption filter (not shown) integrated in it. Illumination light from a fluorescent light source 14 of a reflected illumination light system 13 is incident on the fluorescent cube 12. The fluorescent light source 14 is disposed at the backside of the microscope.

An image-forming lens 15 is disposed below the fluorescent cube 12. Light from the objective lens 11 is incident on the image-forming lens 15. In this case, the image-forming lens 15 works to focus incident light at a position of a focal distance to form a primary image. The image-forming lens 15 is chosen to match the objective lens 11, an infinity corrected objective lens, used for infinity imaging. As a result, there is no lens system between the image-forming lens 15 and the primary focal plane in each different optical path, and the image in each optical path is not magnified. Since the objective lens 11 is of a design corrected to infinity, light between the image-forming lens 15 and the objective lens 11 has parallel rays. In this case, for example, while light is being focused on the sample 9, the primary focal plane does not move, even if the objective lens 11 is moved up and down by using a focusing handle. So a revolver 10 having an up and down system is used as a focusing system in this embodiment.

Light transmitted through the image-forming lens 15 is incident on an optical element 16. The optical element 16 as shown in FIG. 1 includes a prism 16a, and a prism 16b which abut each other in a direction perpendicular to the optical axis of light from the image-forming lens 15. The prism 16a comprises a half transmitting surface to transmit light from the image-forming lens 15 through to direct the light to an observation optical path 17b. Also, the half transmitting surface reflects light from the image-forming lens 15 in a direction of an imaging optical path 17a, which is perpendicular to the optical axis, and is on the opposite side of a researcher (the backside of the frame 1). The prism 16b totally transmits light from the image-forming lens 15 through to lead the light to the observation optical path 17b. The prisms 16a, and 16b are movably supported by a holder 18 shown as a broken line in FIG. 1. The prisms 16a, and 16b supported in a holder 18 are horizontally moved between positions A and B by using a position adjusting knob 19.

In the case where the position-adjusting knob 19 is in the position A, the prism 16a is disposed in the optical path of light from the image-forming lens 15. Light from the image-forming lens 15 is led to the imaging optical path 17a, and is focused on a primary focal plane 29a. In the case where the position-adjusting knob 19 is in the position B, the prism 16b is disposed in the optical path of light from the image-forming lens 15, and transmits light from the image-forming lens 15. That is, either the prism 16a or the prism 16b is selectively inserted into the optical path of light from the image-forming lens 15. As a result, the researcher can direct the light from the image-forming lens 15 to the imaging optical path 17a, or can direct the light to both the imaging optical path 17a and the observation optical path 17b. Since the holder 18 can support three or more prisms, the holder 18 may also support a prism directing light from the image-forming lens 15 to a side port of the microscope. The side port is disposed on the right or left side, or both, of the microscope. The optical element 16 may be attached to be removable from the frame 1. Also, the transmittance of the optical element 16 can be changed voluntarily.

A backside port 100 is placed in the backside of the frame 1 to intersect the imaging optical path 17a. The backside port 100 is used as an imaging port. An adapter 101 for attaching a camera thereto is attached to the backside port 100. The adapter 101 is removable from the backside port 100. The adapter 101 is an adapter for a TV camera, for example, C mount, and ENG mount. Therefore, a magnified image of the sample 9 can be captured by the steps of attaching a TV camera to the frame 1, locating an image plane of the TV camera 102 in the primary focal plane 29a, and focusing light from the image-forming lens 15 on the primary focal plane 29a (the image plane).

On the other hand, light transmitted through the prisms 16a, and 16b passes along the observation light path 17b. Light going along the observation light path 17b is incident on an optical element 22, and is reflected by the optical element 22. Light reflected by the optical element 22 is focused on a primary focal plane 29e. A photo mask and a scale glass can be inserted into the primary focal plane 29e. The photo mask, for example, a glass having a reticle to make sure of the center of an image area imaged on a monitor of the TV camera, is for checking the image area. The scale glass is for checking a size of an image imaged on the monitor of the TV camera.

Light passing through the primary focal plane 29e goes to a lens-barrel 27 via a relay lens system 26 comprising a plurality of lens groups. Light emitted from the relay lens system 26 becomes parallel light rays, and is incident on an image-forming lens 27a disposed inside the lens-barrel 27. The image-forming lens 27a functions to focus incident light on a secondary focal plane 29e′. The secondary focal plane 29e′ is located inside the lens-barrel 27. Therefore, the researcher can observe a magnified image of the sample 9, focused on the secondary focal plane 29e′, via an ocular lens 27b.

As explained above, this first embodiment includes the backside port 100 set in the backside of the frame 1, and the TV camera 102 attached to the backside port 100 by using the adapter 101. As a result, a micromanipulator of the type explained in connection with the prior art does not have physical interference with the TV camera 102, and may be operated precisely even if the micromanipulator is placed in the side space of the inverted microscope. In addition, by using the primary image as the image for the TV camera, a good quality image can be observed by the TV camera 102. That is, to take a weak observation image with high efficiency, an image based on the primary image is better than one based on the secondary image.

Furthermore, by using the backside port 100, it is not necessary to make a hole in a desk to locate the TV camera, and to provide a structure to insert between the desk and the bottom face of the microscope to raise the microscope. As a result, the equipment for the microscope will be simple.

In addition, by attaching the TV camera 102 to the backside port 102, a cable for the TV camera 102 may be disposed further away than before, so that ability of researcher to operate is improved.

(Second Illustrative Embodiment)

FIGS. 3 shows a schematic diagram of a substantial part of a second embodiment of the inverted microscope of the invention. The components in FIG. 3 that are the same as those in FIGS. 1, and 2 are given the same reference numbers.

A typical inverted microscope includes a photo mask attached to the imaging port disposed in the observation optical path 17b, or a scale glass as explained in connection with the first embodiment. Either the photo mask or the scale glass can be inserted into the observation optical path 17b to be disposed in the focal plane which is one of the primary focal plane and the second focal plane. In this way, an image of the sample 9, which overlaps the photo mask or the scale glass, can be seen by the eye. In this case, checking of the image area of the camera is done indirectly by using the photo mask. Therefore, it is necessary that the center of the optical axis of the camera is aligned with the center of the photo mask. Also, the camera must be attached so that the image plane of the camera is placed at a focal plane of the imaging optical path 17a.

The camera, for example, a TV camera, a 35 mm camera, and so on, is selected according to a specific purpose or need. Therefore, the position of the adapter 101 shown in FIG. 1 has to be adjusted to meet the requirements explained above. Conventionally, such optical adjustment including alignment is accomplished in the factory, where the microscope is made, before the microscope is shipped. Then, it is difficult to make optical adjustment after the microscope is shipped.

In this second embodiment, the microscope includes adapters 201 and 202 as means for adjusting. The adapters 201 and 202 make it easy to adjust the position of the backside port 100 to the frame 1 after the microscope is shipped.

Preferably, cylindrical tubes are used as adapters 201 and 202. The adapter 201 is coupled to the backside port 100, and is movable to make fine adjustment in a direction perpendicular to an optical axis of the imaging optical path 17a. Also, the adapter 201 can be fixed to the backside port 100 by using a screw 203. The adapter 202 is coupled to an end portion of the adapter 201, and is coupled to the camera. Also, the adapter 202 is movable to make fine adjustment in a direction parallel to the optical axis of the imaging optical path 17a. That is, the adapter 202 relatively slides on the adapter 201. In addition, the adapter 202 can be fixed to the adapter 201 by using a screw 204.

Therefore, light reflected from the optical element 16 is directed to the imaging optical path 17a, and is focused on the primary focal plane 29a, which is positioned outside of the frame 1 a little, in a hollow portion of the adapter 201. Then, a primary image formed in the primary focal plane 29a is magnified by a lens 205 supported by the adapter 201, and is focused on the secondary focal plane 29a′. A secondary image formed at the secondary focal plane 29a′ is captured, and imaged by the camera.

On the other hand, light transmitted through the optical element 16 is led to the observation optical path 17b, is incident on the optical element 22, and is reflected by the optical element 22. Then, light reflected by the optical element 22 is focused on the primary focal plane 29e. A primary image formed at the primary focal plane 29e is focused on the secondary focal plane 29e′ via the relay lens system 26 and the image-forming lens 27a, and is observed by using an ocular lens 27b.

Following is an explanation of a process to adjust the position of the backside port 100.

First of all, the photo mask is located at a focal plane, the second focal plane 29e′, of the ocular lens 27. Then, the sample 9 is put on the stage 8. A magnified image of sample 9 is observed by using the ocular lens 27b, and then the magnified image of the sample 9 is focused by using the focusing handle so that the magnified image and the photo mask can be observed clearly at once. Next, a position of the sample 9 is adjusted by moving the stage 8 so that a certain position of the magnified image of the sample 9 accords with a central portion of the photo mask on the magnified image observed by the researcher.

Furthermore, an image of the sample 9, which is displayed on the monitor on the basis of an output signal from the camera, is focused by moving the camera. Next, a central portion of the displayed image is accorded with the certain position of the magnified image of the sample 9 by moving the camera. The adapters 201 and 202 are used to move, and adjust the position of the camera. That is, the adapter 201 moves to make a fine adjustment in a direction perpendicular to the optical axis of the imaging optical path 17a, and then, the adapter 202 moves to make a fine adjustment in a direction parallel to the optical axis of the imaging optical path 17a.

By carrying out above adjustment, the image plane of the camera is aligned with the photo mask. In addition, light incident on the photo mask is focused on the photo mask, and light incident on the image plane is focused on the image plane. Furthermore, the image plane of the camera is set to the focal plane of the imaging optical path 17a. That is, the photo mask is parfocal with the image plane of the camera.

Accordingly, the researcher can get the best conditions to capture the image of the sample by easily adjusting a position of the selected camera even if the researcher uses different cameras, each having a different image plane position.

(Third Illustrative Embodiment)

In the case where a lamp housing of the fluorescent light source 14 included in the reflected illumination light system 13 is disposed on the backside of the frame 1, and the TV camera 102 is attached to the backside port 100 of the frame 1, it is difficult to attach the TV camera to the backside port 100 because the lamp housing and the TV camera physically interfere.

In this third embodiment, it is easy to attach the TV camera 102 to the backside port 100.

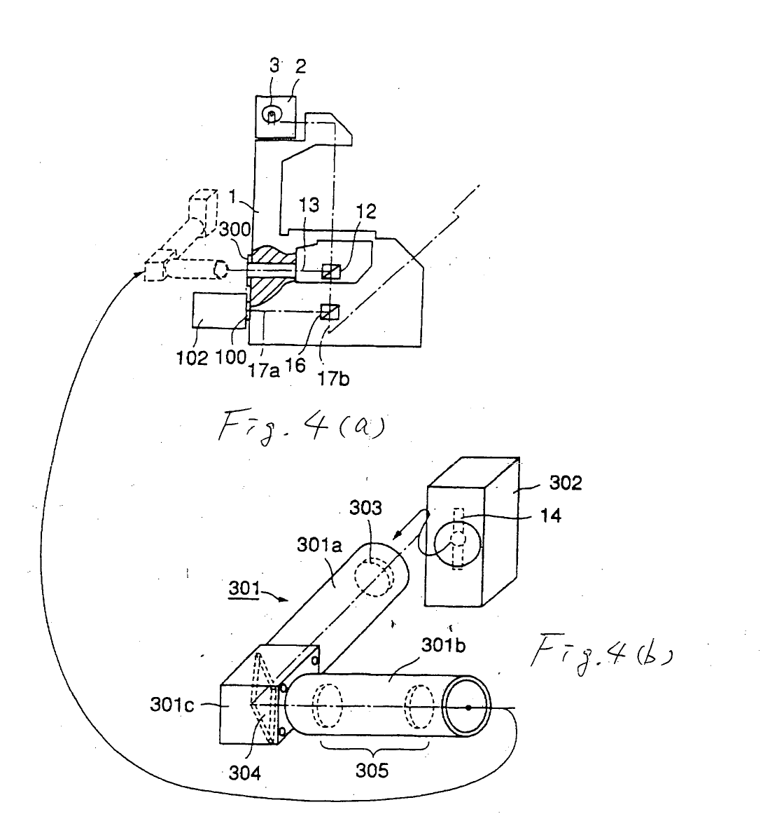

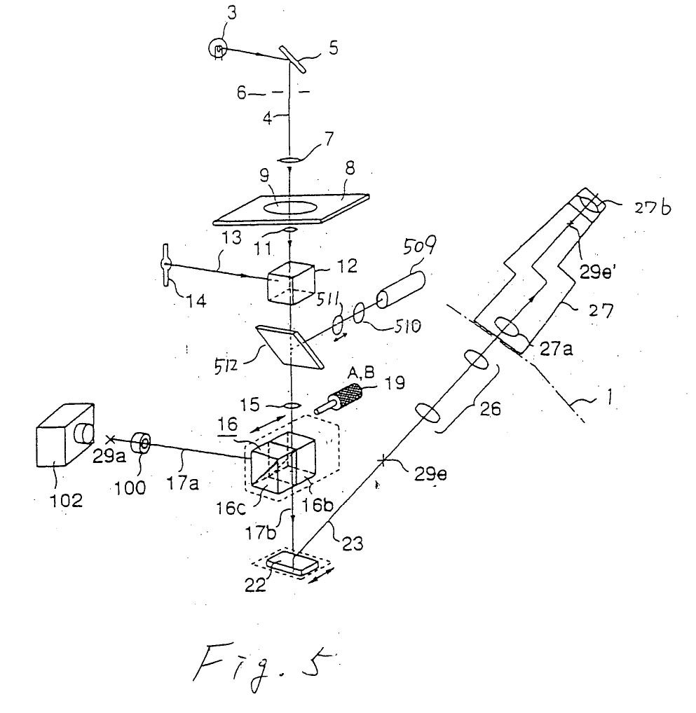

FIGS. 4(a), and 4(b) a schematic diagram of a substantial part of a third embodiment of the inverted microscope of the invention. The components in FIGS. 4(a), and 4(b) that are the same as those in FIGS. 1 and 2 are given the same reference numbers.

In FIGS. 4(a) and 4(b), the TV camera 102 is attached to the backside port 100, and an adapter 300 is placed in the position of the optical path of the reflected illumination light system 13. Also, the adapter 300 is placed at the backside of the frame 1. A reflected illuminator 301 is attached to the adapter 300. The reflected illuminator 301 is removable to the adapter 300. The reflected illuminator 301 includes a first reflected illuminator 301a, a second reflected illuminator 301b, and a relay tube 301c, which couples the first reflected illuminator 301a and the second reflected illuminator 301b. The first reflected illuminator 301a is coupled to the second reflected illuminator 301b at an angle of 90 degrees via the relay tube 301c. A lamp housing 302 comprising the fluorescent light source 14 is attached to the first reflected illuminator 301a, and then, the second reflected illuminator 301b is attached to the adapter 300. In case that a lamp housing 302 is attached to the first reflected illuminator 301a, a male dovetail formed in the side of the lamp housing 302 is inserted into a female dovetail formed at the end of the first reflected illuminator 301a.

Illumination light emitted from the fluorescent light source 14 is transformed into parallel light rays by a collector lens 303 disposed in the first reflected illuminator 301a. The parallel light rays are reflected by a reflecting mirror 304 disposed in the relay tube 301c, are directed to the inside of the frame 1 as reflected illumination light via a lens system 305 disposed in the second reflected illuminator 301b, and are incident on the fluorescent cube 12.

Therefore, the lamp housing 302 disposed at the backside of the frame 1 can be located far from the TV camera 102 by using a curved structure made by the first reflected illuminator 301a, the second reflected illuminator 301b, and the relay tube 301c, even if the TV camera 102 attached to the backside port 100 is huge. As a result, the inconvenience of the physical interference between the lamp housing and the TV camera is resolved, and, it then becomes easy to place the TV camera at the backside port 100. In addition, a bad influence on the TV camera 102 from heat radiating from the lamp housing 302 can be avoided.

The lamp housing 302 shown in FIG. 4(a) is supported in the direction of the right side of the frame 1. Also, the lamp housing 302 may be supported in the direction of the left side of the frame 1. A fiber light source may be used instead of the lamp housing 302. In a case where a fiber light source is used, the physical shape of the reflected illuminator 301 is not a consideration, for example, the fiber light source may be attached to a reflected illuminator 301 shaped into a straight structure.

(Fourth Illustrative Embodiment)

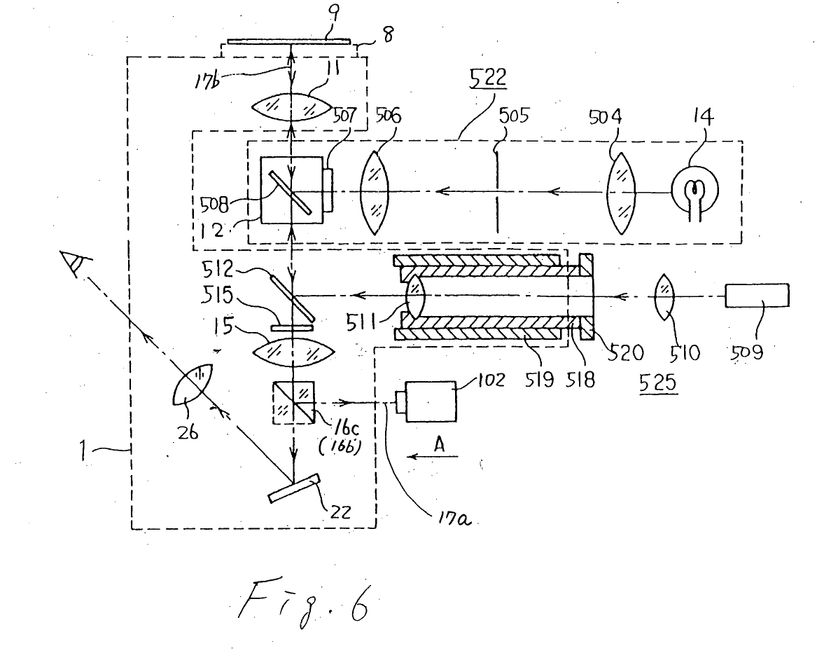

The following explanation by using FIGS. 5 and 6 is with regard to a fourth embodiment. This fourth embodiment enables using a laser beam for operating on a sample. FIG. 5 is an oblique perspective diagram of an inverted microscope of the fourth embodiment of the invention to show a basic construction of the microscope. The components in FIGS. 5, and 6 that are the same as those in FIGS. 1 and 2 are given the same reference numbers. In FIG. 5, a dichroic mirror 512 is disposed between the fluorescent cube 12 and the image-forming lens 15 to direct a laser beam emitted from a light source 509 to the sample. Furthermore, as the optical element 16, either the prism 16b (hereinafter called the total transmission prism 16b) or a total reflection prism 16c is disposed at a point where the imaging optical path 17a and the observation optical path 17b cross each other. Although the light source 509 shown in FIG. 5 is disposed to provide the laser beam to the dichroic mirror 512 from the right side, an optical system to direct the laser beam to the dichroic mirror 512 may be constructed to provide the laser beam to the dichroic mirror 512 from either the left side or the backside. Referring to FIG. 6, the details of an optical path of the laser beam and a reflected illumination fluorescence system 522 will be explained.

FIG. 6 is shows schematic diagram of a substantial part of the fourth embodiment of the inverted microscope. In FIG. 6, the sample 9 is disposed on a stage 8. The objective lens 11 is disposed below the sample 9. The reflected illumination fluorescence system 522 emitting excitation light for fluorescence observation is disposed below the objective lens 11. The reflected illumination fluorescence system 522 is removably attached to the body of the microscope shown in FIG. 6 as a broken line. The reflected illumination fluorescence system 522 includes the fluorescent light source 14, a collector lens 504, a field stop 505, a projection lens 506, an excitation filter 507, and a dichroic mirror 508. For example, a mercury lamp or a xenon lamp is used as the fluorescent light source 14. The excitation filter 507 and the dichroic mirror 508 are placed in the fluorescent cube 12, and are removable from the reflected illumination fluorescence system 522.

The body of the microscope includes the dichroic mirror 512, the image-forming lens 15, the total reflection prism 16c, an absorption filter 515, the optical element (mirror) 22, and the lens system 26. The body of the microscope includes the above elements so that observation light from the sample 9 is incident on the optical element 16c (or 16b). Observation light from the sample 9 is led to the optical element 16 via the objective lens 11, the dichroic mirror 508, the dichroic mirror 512, the absorption filter 515, and the image-forming lens 15. In a case where total reflection prism 16c is disposed in the observation optical path 17b, observation light incident on the total reflection prism 16 is deflected in a lateral direction, and is led to the imaging optical path 17a so as to be imaged on the TV camera 102 attached to the body of the microscope. In a case where the total transmission prism 16b is disposed in the observation optical path 17b, observation light is reflected by the optical element 22, and transmitted through the lens system 26 so as to be observed directly by the eye.

On the other hand, in the body of the microscope, a laser beam input system 525 is disposed in parallel with the reflected illumination fluorescence system 522. The laser beam input system 525 emits a laser beam to operate on the sample 9, and includes the light source 509, a beam expander lens 510 for expanding the laser beam, and a image-forming lens 511 for the laser beam. The laser beam from the light source 509 is transmitted through the beam expander lens 510, the image-forming lens 511, and is reflected upwardly by the dichroic mirror 512. Furthermore, the laser beam reflected by the dichroic mirror 512 is transmitted through the dichroic mirror 508 and the objective lens 11 so as to be incident on the sample 9.

The image-forming lens 511 is supported by a movable member 518. The movable member is preferably tubular, and is movable along a hollow portion of a tubular fixed member 519 (hereinafter called the fixed member). The movable member 518 includes a knob 520. The movable member is moved by moving the knob 520. As a result, the image-forming lens 511 is moved in a direction of the optical path of the laser beam. The fixed member is attached to the body of the microscope by using one or more screws, and is removable from the body.

In this fourth embodiment, a B excitation method is used as a reflected illumination observation method. The wavelength of the light from the light source 509 is 340 nm. The excitation filter has an optical characteristic to transmit light having a wavelength between 470 nm and 490 nm. The dichroic mirror 508 has optical characteristic to transmit light having a wavelength of 340 nm±10 nm and over 500 nm. The dichroic mirror 512 has an optical characteristic to reflect light having a wavelength of 340 nm±10 nm. The absorption filter 515 has an optical characteristic to transmit light having a wavelength of 515 nm, or more.

Excitation light emitted from the light source 14 is transmitted through collector lens 504, the field stop 505, the projection lens 506, and the excitation filter 507. Light transmitted through the excitation filter 507 becomes excitation light having a wavelength between 470 nm and 490 nm according to the optical characteristic of the excitation filter 507, and is incident on the dichroic mirror 508. Excitation light is reflected in the direction of the objective lens 11 by the dichroic mirror 508, and is transmitted through the objective lens 11 so as to be incident on the sample 9.

Observation light from the sample 9 is transmitted through the objective lens 11, and is incident on the dichroic mirror 508. According to the optical characteristic of the dichroic mirror 508, observation light having a wavelength of over 500 nm is transmitted through the dichroic mirror 508, and is incident on the dichroic mirror 512. According to the optical characteristic of the dichroic mirror 512, observation light having a wavelength of over 500 nm is transmitted through the dichroic mirror 512. According to optical characteristic of the absorption filter 515, light having a wavelength of over 515 nm is transmitted through the absorption filter 515. An image of observation light is formed by the image-forming lens 15, and is incident on the total reflection prism 16c.

Observation light incident on the total reflection prism 16c is deflected in a lateral direction, and is incident on the TV camera 102. Observation light incident on the TV camera 102 is imaged, and is displayed on a monitor (not shown) as an observation image. In the case where the total transmission prism 16b is disposed in the observation optical path 17b, observation light is reflected by the optical element 22, and transmitted through the lens system 26 so as to be observed directly by the eye.

On the other hand, when the laser beam is emitted from light source 509, the laser beam is expanded by the beam expander lens 510, is led to the body of the microscope, is incident on the dichroic mirror 512 via the image-forming lens 511, is reflected upwardly by the dichroic mirror 512 on the basis of the optical characteristic of the dichroic mirror 512, is transmitted through the objective lens 11, and is incident on the sample 9. As a result, the sample 9 is operated on by the laser beam emitted from light source 509.

In the situation above, the movable member 518 supporting the image-forming lens 511 is movable along the hollow portion of the fixed member 519. Therefore, the researcher only moves the movable member 518 from outside by using the knob 520 so as to move the image-forming lens 511 in the direction of an optical axis of the laser beam. Even in the situation where a plurality of objective lenses, which each have a different back focal plane, and are attached to the revolver 10, are used in observation, the laser beam is focused on the best point for the selected objective lens 11 by only moving the image-forming lens 511 with the moving member 518. As a result, the sample 9 is operated upon under stable conditions. In addition, the fixed member 519 having the movable member 518 is secured in the body of the microscope by using screws so as to be movable with respect to the body of the microscope. Therefore, if the fixed member 519 having the movable member 518 is attached to a typical microscope, a microscope system including the typical microscope will be upgraded.

Here, in the case where the wavelength of the laser beam is longer than that of light reflected by the dichroic mirror 508, for example, a solid state diode laser beam having a wavelength of 850 nm is used instead, a dichroic mirror for typical B excitation observation can be used as the dichroic mirror 508. In addition, the application of this embodiment is not limited to B excitation observation. If there is a certain difference between a wavelength of the laser beam and that of excitation light for reflected illumination fluorescence observation, a number of applications can be carried out corresponding to the optical characteristic of the dichroic mirror 508. Furthermore, in the case of typical transmitted illumination observation (not shown), for example, bright field observation, dark field observation, differential interference contrast observation, and polarization observation, is carried out instead of reflected illumination fluorescence observation, the reflected illumination fluorescence system 522 is unnecessary, and then, a laser application explained above is carried out without hindrance with the body of the microscope. Moreover, the body of the microscope can be combined with either the reflected illumination fluorescence system 522 or a transmitted illumination apparatus for transmitted illumination observation.

(Fifth Illustrative Embodiment)

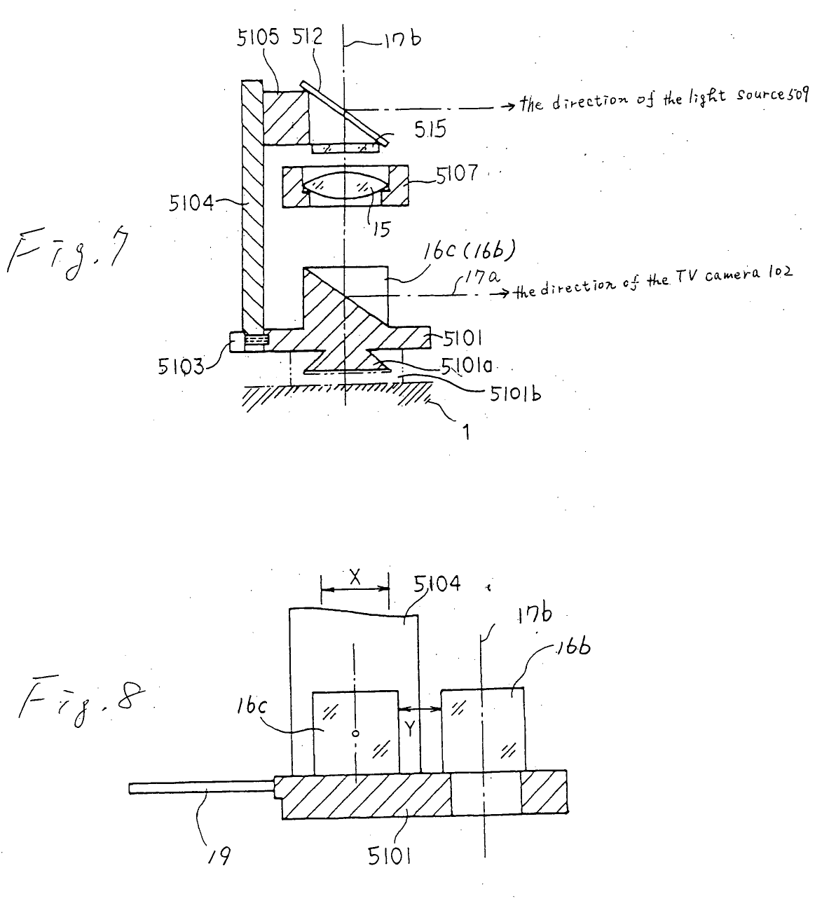

FIG. 7 is schematic diagram of the inverted microscope showing a substantial part of a fifth embodiment of the invention. The components of a basic optical system in FIG. 7 that are the same as those in FIG. 6 are given the same reference numbers.

In FIG. 7, a slider 5101 supports the total transmission prism 16b (not shown) and the total reflection prism 16c, and functions as a moving means for moving the total transmission prism 16b and the total reflection prism 16c. The prisms 16b, and 16c abut each other in a direction perpendicular to a plane of the drawing paper of FIG. 7. The slider 5101 includes a sliding-parallel-dovetail 5101a, a male dovetail, which is inserted into a female dovetail 5101b fixed in the body of the microscope. The slider 5101 includes the position adjusting knob 19 shown in FIG. 6. The position adjusting knob 19 is attached to the body of the microscope to operate the slider 5101 from the outside. That is, the slider is movable in a direction perpendicular to the plane of the drawing paper of FIG. 7 along the dovetail 5101a by using the position adjusting knob 19 so as to dispose either the total transmission prism 16b or the total reflection prism 16c in the observation optical path 17b.

A column extending vertically from the base arm is attached to the slider 5101 by using a screw 5103. An upper arm 5105 is disposed at the end portion of the column 5104 as a fixing member. The dichroic mirror 512 and the absorption filter 515 are integrated, and are attached to the upper arm 5105 by using a blade spring (not shown) to be disposed above the total reflection prism 16c. In addition, the dichroic mirror 512 and the absorption filter 515 can be removed from the upper arm 5105.

As explained above, the total reflection prism 16c, total transmission prism 16b, the dichroic mirror 512, and the absorption filter 515 can slide on the female dovetail 5101b with together as one unit. In addition, the unit can be removed from the body of the microscope.

The image-forming lens 15 disposed between the absorption filter 515 and the total reflection prism 16c is fixed to a fixing member 5107 inside the body of the microscope.

In the meantime, if carrying out a biological application, there is a very little probability that the laser beam will be reflected by the sample 9. Here, in the case that the wavelength of reflected laser light from the sample 9 is shorter than that of reflected fluorescence observation light, for example, B excitation is carried out and the wavelength of the laser beam is 340 nm, strong light harmful to the eyes, such as ultraviolet light rays with a wavelength of 340 nm is absorbed by the absorption filter 515. However, the absorption filter 515 can not absorb the harmful light completely. Therefore, there is a small probability that laser beam will be transmitted through the absorption filter 515, that is, there is probability that the harmful light can reach eyes. Moreover, in a case where the wavelength of the laser beam is longer than the wavelength of reflected fluorescence observation light, for example, when B excitation is carried out and the wavelength of the laser beam is 850 nm, light of the 850 nm wavelength is transmitted through the absorption filter 515, so that the researcher can not observe the sample 9 directly with his eyes.

However, in carrying out this fifth embodiment explained above, in a case where an operation laser beam is used, the total reflection prism 16c is inserted into the observation optical path 17b by using the slider 5101, and also the dichroic mirror 512 and the absorption filter 515 are inserted into the observation optical path 17b at the same time. Therefore, the laser beam is not reflected as long as the total reflected prism 16c is inserted into the observation optical path 17b. Also, observation light transmitted through the absorption filter 515 incident on the total reflection prism 16c via the image-forming lens 15, and then light reflected by the total reflection prism 16c can be captured by the TV camera 102.

In a case where the researcher observes the sample with his eyes, the total transmission prism 16b is inserted into the observation optical path 17b by using the slider 5101, and the total reflection prism 16c, the dichroic mirror 512, and the absroption filter 515 are removed from the observation optical path 17b. Therefore, even if the laser beam from the light source 509 is incident on the body of the microscope, the laser beam can not be observed by the researcher because the dichroic mirror 512 is not in the observation optical path 17b to reflect the laser beam in the direction of the sample 9.

This fifth embodiment has the same advantage that the fourth embodiment has. Also, this embodiment has the advantage of improving safety for the researcher. In addition, if some different kind of laser beams are used for the microscope system with this invention, the dichroic mirror 512 and the absorption filter 515 can be changed easily because the total reflection prism 16c, the dichroic mirror 512, and the absorption filter 515 can be removed from the body of the microscope.

Furthermore, for more safety, the following structure can be employed. A shutter is inserted into the laser light path of the light source 509, and is linked with a shutter electrically. The shutter is opened and closed by a signal from the optical light sensor. As a result, the shutter is opened when the total reflection prism 16c is inserted into the observation optical path 17b.

(Sixth Illustrative Embodiment)

FIG. 8 is schematic diagram of the inverted microscope showing a substantial part of a sixth embodiment of the invention. FIG. 8 shows the total reflection prism 16c seen from a direction of an arrow A in FIG. 6. The components of the basic optical system in FIG. 8 that are the same as those in FIG. 6 are given the same reference numbers. In FIG. 8, the slider 5101 includes the total reflection prism 16c, and the total transmission prism 16b. Both prisms 16b and 16c are disposed in a row.

The position adjusting knob 19 acting as an operating member is fixed to the slider 5101, and is used for sliding the slider 5101 from the outside of the body of the microscope. As a result, by moving the position adjusting knob 19, either of the prisms 16b or 16c is selectively inserted into the observation optical path 17b as in the fifth embodiment.

Here, in a case where the distance between the prisms 16b and 16c is defined as a distance “Y”, the distance “Y” is set up to be longer than a half of a longest length “X” of diameter of the observation optical path 17b, that is, the relationship Y>(½)X exists. There is no hole and filter in the middle of the slider 5101 between prisms 16b and 16c so that light cannot pass or be transmitted through the slider 5101 while the slider 5101 is moved to insert either the prism 16b or the prism 16c into the observation optical path 17b. Therefore, a researcher can observe the sample safely.

Moreover, the sixth embodiment will be much useful if carried out with the structure of the fifth embodiment. In addition, although the fourth, fifth, and sixth embodiments have been explained in respect to a microscope, which has an imaging port in the backside of the microscope, shown in FIG. 1, the position of the imaging port is not limited to the backside of the microscope. For example, the imaging port can be placed at either the right or left side of the microscope. Furthermore, the fourth, fifth, and sixth embodiments can be applied to an erect microscope.

Accordingly, various modifications may be made without departing from the spirit or scope of the general inventive concept as defined by the appended claims and their equivalents.

1-10. (cancelled)

11. An inverted microscope comprising:
an objective lens for magnifying an image of a sample, disposed below the sample;
a first light source for emitting excitation light to illuminate the sample via said objective lens;
a second light source for emitting a laser beam to illuminate the sample via said objective lens;
an image-forming lens for said laser beam for focusing said laser beam on the sample via said objective lens;
a lens holder for supporting said image-forming lens for said laser beam, the lens holder enabling said image-forming lens for said laser beam to move in a direction of an optical axis of said laser beam for adjusting a position of said image-forming lens for said laser beam so that said laser beam is focused on an appropriate position for said objective lens;
a first optical element for directing light from the sample to an imaging port;
a second optical element for directing said excitation light from the first light source to the sample;
a third optical element for directing said laser beam from said second light source to the sample;
a moving mechanism in which said first optical element and third optical element are mounted, for removing said first optical element and said third optical element from an observation optical path at the same time; and wherein
said first optical element comprises a total reflection prism,
said moving mechanism further holds a total transmission prism for directing light from the sample to an ocular lens, and selectively inserts said first optical element and said total transmission prism in said observation optical path through a movement of said moving mechanism, and
in said moving mechanism, the distance Y, which is the distance between said total reflection prism and said total transmission prism, is set to be longer than a half of the diameter X, which is the maximum diameter of a light flux of said observation optical path.

12-42. (cancelled).

43. The inverted microscope according to claim 11, wherein the second optical element includes a fluorescent cube and the third optical element includes a dichroic mirror.

44. An inverted microscope comprising:
an objective lens disposed below a sample;
a first image-forming lens for focusing observation light from said objective lens, said first image-forming lens imaging said observation light at a focal plane;
a reflecting mirror for directing transmitted light passing through said first image-forming lens to a front side of the microscope;
a first optical element disposed between said first image-forming lens and said reflecting mirror, for directing light from said first image-forming lens to the backside of the microscope to form an imaging optical path, which backside is the opposite side of the front side of the microscope on which a lens-barrel is disposed;
a port in said microscope, said imaging optical path passing through said port;
an imaging device coupled to said port, said imaging device being for taking an image that is, at least originally, formed by the first image-forming lens;
a first light source, located on said backside, for emitting excitation light to illuminate the sample via said objective lens;
a second optical element disposed in an observation optical path along the optical axis of said objective lens, for directing said excitation light from the first light source to the sample, and for transmitting observation light from the sample;
a second light source for emitting a laser beam incident on the sample via said objective lens;
a third optical element disposed in said observation optical path, for directing said laser beam from said second light source to the sample, and for transmitting said observation light from the sample and directing said observation light to said first optical element; and
an second image-forming lens for said laser beam disposed between said second light source and said third optical element, for focusing said laser beam on the sample;
a moving mechanism in which said first optical element and said third optical element are disposed, for removing said first optical element and said third optical element from said observation optical path at the same time, wherein:
said first optical element comprises a total reflection prism,
said moving mechanism further holds a total transmission prism for transmitting light from said image forming lens to the reflecting mirror, and selectively inserts said first optical element or said total transmission prism into the observation optical path through a movement of said moving mechanism, and
in said moving mechanism, the distance Y, which is the distance between said total reflection prism and said total transmission prism, is set to be longer than a half of the diameter X, which is the maximum diameter of a light flux of said observation optical path.

45-46. (cancelled).

47. An inverted microscope comprising:
an objective lens disposed below a sample;
a first image-forming lens for focusing observation light from said objective lens, said first image-forming lens imaging said observation light at a focal plane;
a reflecting mirror for directing transmitted light passing through said first image-forming lens to a lens barrel and an ocular lens;
a first optical element disposed between said first image-forming lens and said reflecting mirror, for directing light from said first image-forming lens to an imaging optical path, the first optical element including an total reflection prism;
a port in said microscope, said imaging optical path passing through said port;
an imaging device coupled to said port, said imaging device having an image plane substantially corresponding to the focal plane of the first image-forming lens;
a first light source, for emitting excitation light to illuminate the sample via said objective lens;
a second optical element disposed in an observation optical path along the optical axis of said objective lens, for directing said excitation light from the first light source to the sample, and for transmitting observation light from the sample;
a second light source for emitting a laser beam incident on the sample via said objective lens;
a third optical element disposed in said observation optical path, for directing said laser beam from said second light source to the sample, and for transmitting said observation light from the sample and directing said observation light to said first optical element;
a second image-forming lens for said laser beam disposed between said second light source and said third optical element, for focusing said laser beam on the sample;
a lens holder for holding the second image-forming lens for said laser beam, the lens holder moving along the optical axis of the laser beam to adjust the position of the second image-forming lens so that the laser beam is focused on an appropriate position for the objective lens; and
a moving mechanism on which the first optical element and the third optical element are disposed, the moving mechanism removing the first optical element and third optical element from the observation optical path at the same time, wherein
the moving mechanism changes its status so that the light from the first light source and the laser beam from the second light source are directed to the imaging device when the second light source is used, and the light from the first light source is directed to the ocular lens when the second light source is not used,
the moving mechanism further comprising a total transmission prism, the moving mechanism inserts the total reflection prism and the third optical element into the observation optical path when the second light source is used, and the moving mechanism inserts the total transmission prism into the observation path, and
in the moving mechanism, the distance Y which is the distance between the total reflection prism and the total transmission prism is set to be longer than a half of the diameter X which is the maximum diameter of the light flux of the observation light path.

48-60. (cancelled).
